(19) United States
(12) Patent Application Publication
(10) Pub. No.: US 2009/0085236 A1
(43) Pub. Date: Apr. 2, 2009

(54) FILM STRETCHING METHOD AND SOLUTION CASTING METHOD

(75) Inventors: Toshinao Arai, Kanagawa (JP); Misao Takahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/239,686

(22) Filed: Sep. 26, 2008

(30) Foreign Application Priority Data
Sep. 27, 2007 (JP) 2007-250768

(51) Int. Cl. G02B 1/08

(52) U.S. Cl. 264/1.34

(57) ABSTRACT

A TAC film has a thickness profile in which its thickness decreases from side edge portions toward a center portion. The TAC film has a retardation profile in which its in-plane retardation Re decreases from the side edge portions toward the center portion. The retardation profile is caused by the thickness profile. In a tenter section, the TAC film is stretched in a width direction while the side edge portions are being held. A difference of increase in the in-plane retardation Re of the film in the width direction after the stretching is compensated by a difference of the in-plane retardation Re of the film in the width direction before the stretching.

### FIELD OF THE INVENTION

The present invention relates to a film stretching method and a solution casting method.

### BACKGROUND OF THE INVENTION

Recently, in accordance with rapid development and popularization of liquid crystal display (LCD) or the like, the demand for a cellulose acylate film, in particular, a triacetyl cellulose (TAC) film used as a protective film for polarizing films or the like, has been increasing. According to the increase in the demand for the TAC film, the improvement in productivity thereof has been desired. The TAC film is produced in the following method. A dope containing the TAC and a solvent is cast through a casting die onto a support continuously moving to form a casting film thereon. The casting film is dried or cooled to have a self-supporting property. A self-supporting casting film is peeled from the support to form a wet film. The wet film is dried and wound as a film. According to a solution casting method described above, it is possible to form a film containing less foreign materials and having more excellent optical properties in comparison with a film forming method by melt-extrusion.

As a method for adjusting the optical properties, especially retardation, of the TAC film, the following method is known. To arrange polymer molecules in a predetermined direction, the TAC film is stretched in a predetermined direction while side edges thereof are held with, for example, clips by using a tenter or the like (see Japanese Patent Laid-open Publication No. 2002-311240, for example).

However, according to the method of stretching the long TAC film in a film width direction while holding the side edges thereof with clips or the like, as disclosed in the Japanese Patent Laid-open Publication No. 2002-311240, the orientation of the polymer molecules occurs unevenly. Specifically, the polymer molecules orientation is more likely to occur at a center portion of the TAC film as compared to the side edge portions and around the side edge portions of the TAC film. That is, the amount of increase in in-plane retardation Re increases from the side edge portions to the center portion. Such TAC film having uneven in-plane retardation Re in the film width direction exerts optical anisotropy, and therefore not preferable as the protective film. It is possible to cut out the portion with even in-plane retardation Re as a product film by cutting off the side edge portions of the TAC film after the stretching. However, the amount of the portions being cut off may increase as the unevenness of the in-plane retardation Re increases, which limits the improvement in productivity.

### SUMMARY OF THE INVENTION

It is an object of the present invention to provide a film stretching method that provides a film with desired in-plane retardation Re while controlling unevenness of the in-plane retardation Re in a width direction. It is another object of the present invention to provide a solution casting method for effectively producing a film with even in-plane retardation Re.

In order to achieve the above objects and other objects, a film stretching method of the present invention includes preparing step and stretching step. In the preparing step, a film having a thickness profile in which a thickness of the film decreases from side edge portions toward a center portion in a width direction and a retardation profile in which an in-plane retardation Re of the film decreases from the side edge portions toward the center portion in the width direction is prepared. In the stretching step, the film is stretched in the width direction while the side edge portions thereof are being held. The film has a stretching property that decreases as closer to the side edge portions. The in-plane retardation Re increases after the stretching step. At this time, an increase in the in-plane retardation Re becomes larger from the side edge portions toward the center portion. The stretching property causes a difference of the increase in the in-plane retardation Re in the width direction. A difference of the in-plane retardation Re in the width direction before the stretching step compensates the difference of the increase in the in-plane retardation Re in the width direction after the stretching step.

It is preferable that the retardation profile is caused by the thickness profile.

The film thickness preferably satisfies the following formulae (1) and (2):

1.02≦THe/THc≦1.04 (1)

THe−THc≦3 μm (2)

where THe is a thickness of the side edge and THc is a thickness of the center portion.

It is preferable that a content of remaining solvent in the film during the stretching step is at least 0.1 wt. % and at most 10 wt. %. It is also preferable that temperatures of the side edge portions during the stretching step are at least 1° C. and at most 20° C. higher than a temperature of the center portion. It is yet also preferable that the film is composed of a single layer.

A solution casting method of the present invention includes casting step, peeling step, and the stretching step. In the casting step, a dope containing a polymer and a solvent is cast on a support continuously moving and a casting film is formed on the support. In the peeling step, the casting film that is turned into a gel by cooling is peeled as a film. This film has the thickness profile and the retardation profile above described. Then, the above-described stretching step is performed to the film.

It is preferable that the retardation profile is caused by the thickness profile.

According to the stretching method of the present invention, the difference of the increase in the in-plane retardation Re in the width direction after the stretching step is compensated by the difference of the in-plane retardation Re in the width direction before the stretching step. Owing to this, the film can be provided with desired in-plane retardation Re while unevenness of the in-plane retardation Re in the film width direction is controlled. According to the solution casting method of the present invention, the film with even in-plane retardation Re can be effectively produced with ease.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is an explanatory view illustrating an off-line stretching device;

FIG. 2 is a plan view illustrating a configuration of a tenter section;

FIG. 3 is a side elevational view illustrating a configuration of a clip;

FIGS. 4A, 4B and 4C are explanatory views illustrating profiles of properties of a TAC film in a width direction before stretching: FIG. 4A shows a profile of a thickness TH, FIG. 4B shows a profile of a birefringence ΔN, and FIG. 4C shows a profile of an in-plane retardation Re, in which a horizontal axis indicates the width direction of the TAC film and a vertical axis indicates values of the respective properties at the corresponding positions;

FIGS. 5A, 5B, and 5C are explanatory views illustrating profiles of properties of the TAC film in the width direction after stretching: FIG. 5A shows the profile of the thickness TH, FIG. 4B shows the profile of the birefringence ΔN, and FIG. 4C shows the profile of the in-plane retardation Re;

FIG. 6 is a cross-sectional view illustrating the TAC film of the present invention;

FIGS. 7A, 7B, and 7C are explanatory views illustrating profiles of properties of a TAC film in a width direction before stretching: FIG. 7A shows a profile of a content concentration C1 of a retardation increasing agent, FIG. 7B shows the profile of the birefringence ΔN, and FIG. 7C shows the profile of the in-plane retardation Re;

FIGS. 8A, 8B, and 8C are explanatory views illustrating profiles of properties of the TAC film in the width direction after stretching: FIG. 7A shows the profile of the content concentration C1 of the retardation increasing agent, FIG. 7B shows the profile of the birefringence ΔN, and FIG. 7C shows the profile of the in-plane retardation Re;

FIG. 9 is an explanatory view illustrating a solution casting apparatus;

FIG. 10 is a cross-sectional view illustrating a casting die;

FIG. 11 is an explanatory view illustrating a melt extrusion apparatus;

FIG. 12 is a perspective view illustrating the disposition of rollers in a heat treatment zone; and

FIG. 13 is an explanatory view illustrating a film wrapping length D around the roller and a film length G between two adjacent rollers.

### DESCRIPTION OF THE PREFERRED EMBODIMENTS

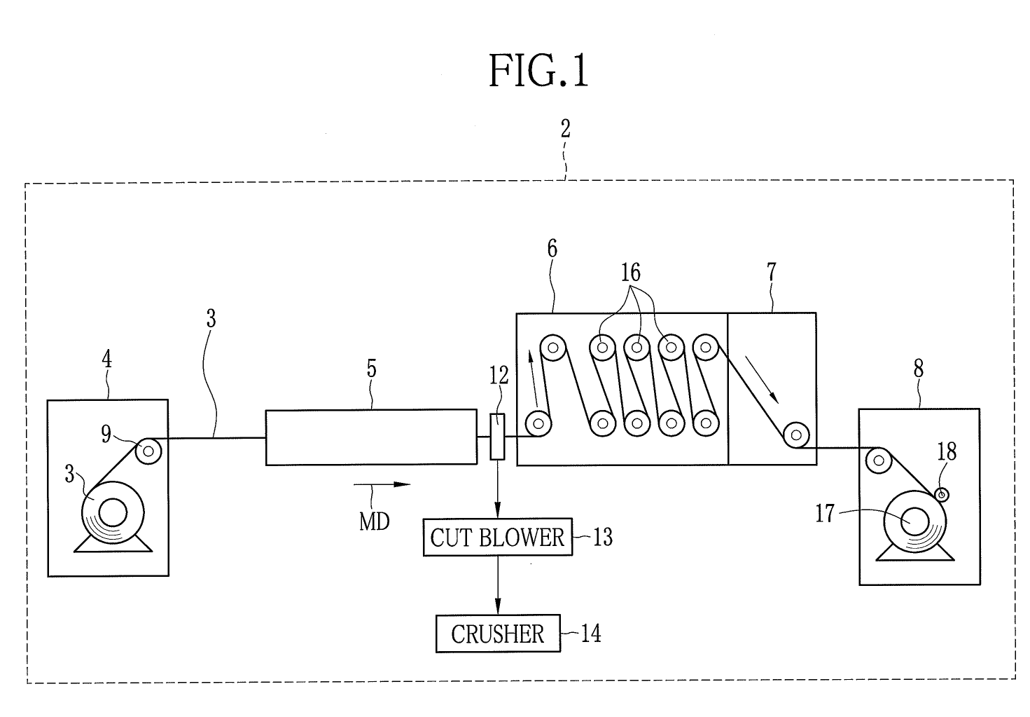

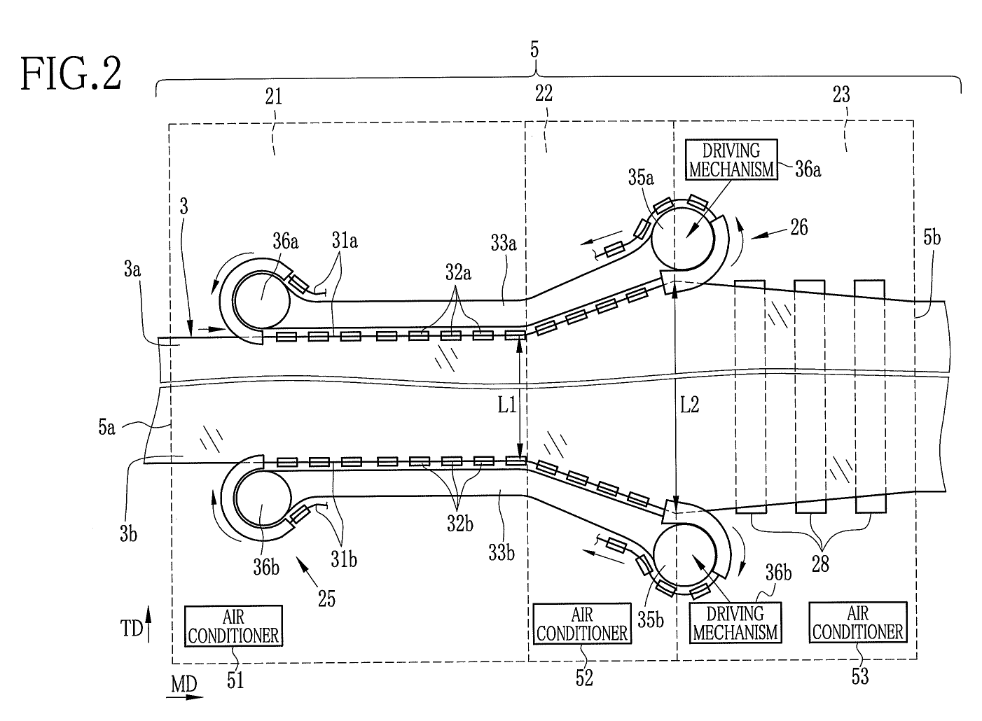

As shown in FIG. 1, an off-line stretching device 2 is used for stretching a long TAC film 3, and includes a film supply chamber 4, a tenter section 5, a relaxation chamber 6, a cooling chamber 7, and a winding chamber 8. The TAC film 3 that has been produced in a solution casting apparatus and wound in a roll form is loaded in the film supply chamber 4. The TAC film 3 is fed to the tenter section 5 by a supply roller 9. In the tenter section 5, a stretching process is performed to the TAC film 3. In the stretching process, both side edge portions 3a and 3b of the TAC film 3 are held with clips or the like and stretched in a width direction TD while the TAC film 3 is being transformed in a direction MD (see FIG. 2).

After being stretched in the tenter section 5, the TAC film 3 is sent to an edge slitting section 12. In the edge slitting section 12, the side edges, which were held with clips, are slit. The slit edges are cut into pieces by a cut blower 13. The side edges thus cut into pieces are sent to a crusher 14 by a not-shown blowing device and crushed into chips by the crusher 14. The chips are reused for preparing the dope, thus resulting in improvement in cost.

The relaxation chamber 6 includes plural rollers 16, and the TAC film 3 is transported by the rollers 16 in the relaxation chamber 6. Air at a desired temperature is blown to the relaxation chamber 6 by a blower (not-shown) to subject the TAC film 3 to heat treatment for stress relaxation. The temperature of the air is preferably in the range of 20° C. to 250° C. After this heat treatment in the relaxation chamber 6, the TAC film 3 is sent to the cooling chamber 7.

In the cooling chamber 7, the TAC film 3 is cooled to be 30° C. or less, and then sent to the wining chamber 8. The winding chamber 8 includes a winding roller 17 and a press roller 18. The TAC film 3 sent to the winding chamber 8 is wound by the winding roller 17 while being pressed by the press roller 18.

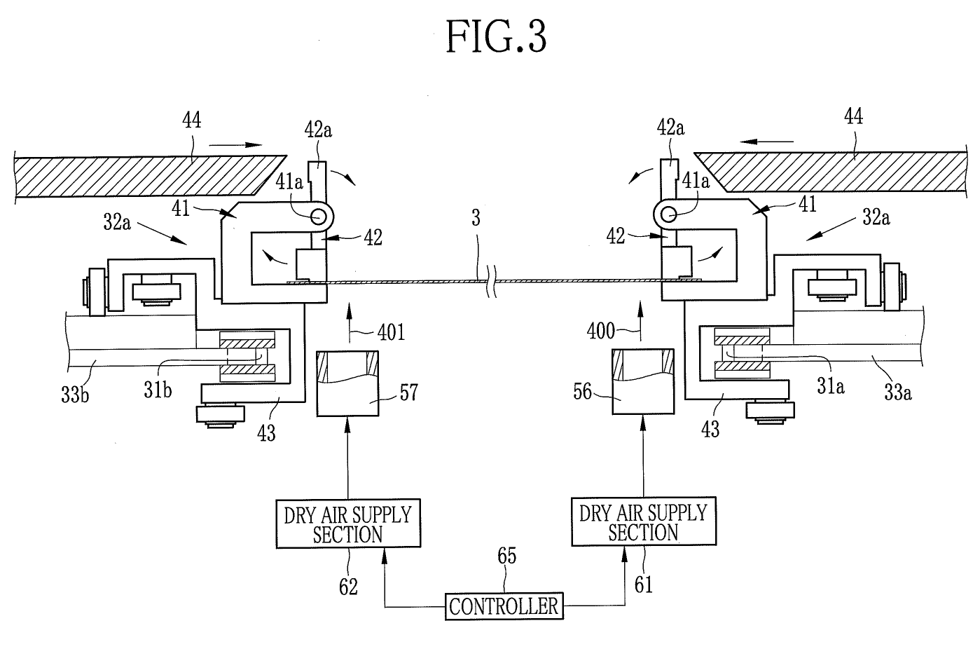

Next, the configuration of the tenter section 5 is explained. As shown in FIGS. 2 and 3, the tenter section 5 has first to third zones 21 to 23 whose drying conditions differ from each other.

In the tenter section 5, the first zone 21 is positioned in the most upstream side, and the second zone 22 follows the first zone 21 in the transfer direction of the TAC film 3, and then the third zone 23 is positioned next to the second zone 22. The first zone 21 is provided with an entrance 5a to which the TAC film 3 sent from the film supply chamber 4 enters, a hold position 25 at which the holding of the side edge portions 3a and 3b of the TAC film 3 initiates, and guide rollers (not shown) for guiding the TAC film 3 from the entrance 5a to the hold position 25. At the boundary of the second zone 22 and the third zone 23 is provided a release position 26 at which the side edge portions 3a and 3b of the TAC film 3 are released. The third zone 23 is provided with transfer rollers 28 for transferring the TAC film 3 that has passed through the release position 26 to downstream in the transfer direction, and an exit 5b from which the TAC film 3 is sent out to the edge slitting device 12. Note that the side edge portions 3a and 3b are defined as areas within 200 mm in the width direction TD from side ends of the TAC film 3.

The tenter section 5 is provided with a pair of chains 31a, 31b running through the first zone 21 to the third zone 23, clips 32a, 32b provided to the chains 31a, 31b at predetermined intervals, guide rails 33a, 33b for guiding the running chains 31a, 31b, chain sprockets 35a, 35b on which the chains 31a, 31b are wound, and driving mechanisms 36a, 36b for driving the chain sprockets 35a, 35b.

As shown in FIG. 3, each clip 32a is constituted of a substantially inverse C-shaped frame 41, a flapper 42, and a rail attachment portion 43. The flapper 42 is rotatably mounted to the frame 41 by an attachment shaft 41a. The flapper 42 shifts between a film holding position and a film releasing position. In the film holding position, as shown in FIG. 3, the flapper 42 stands approximately vertically. In the film releasing position, a releasing member 44 contacts and pushes an engagement head 42a of the flapper 42, and thereby tilting the flapper 42 from the vertical position. That is, the flapper 42 swings around the attachment shaft 41a. The flapper 42 is generally in the holding position under its own weight. The rail attachment portion 43 is attached to the chain 31a. Each clip 32a is guided along the rail 33a without falling off of the chain 31a. Note that each clip 32b has a bilaterally symmetric configuration as the clip 32a. Thus, the clips 32a, 32b endlessly run through the first zone 21 to the third zone 23 under the control of the driving mechanisms 36a, 36b.

When the clips 32a, 32b pass the hold position 25, the releasing members 44 retract from the engagement heads 42a, and thereby putting the flappers 42 into the film holding position by their own weight. Owing to this, the clips 32a, 32b hold the side edge portions 3a, 3b of the TAC film 3. The TAC film 3 whose side edge portions 3a, 3b are being held is guided from the hold position 25 to the release position 26 along with the clips 32a, 32b. When the clips 32a, 32b pass the release position 26, the flappers 42 are put into the film releasing position by the releasing members 44. Owing to this, the clips 32a, 32b release the side edge portions 3a, 3b. The TAC film 3 whose side edge portions 3a, 3b were released from the holding is then guided to the third zone 23. The transfer rollers 28 transfer the TAC film 3 to the exit 5b.

When a distance between the pair of rails 33a, 33b is defined as a “rail distance”, the rail distance is approximately uniform in the first zone 21. In the second zone 22, the pair of rails 33a, 33b is disposed such that the rail distance gradually widened toward the downstream in the transfer direction MD. The TAC film 3 is stretched in the width direction TD at a desired stretching ratio Lx by adjusting the rail distance. Here, the stretching ratio Lx is obtained by a formula of L2/L1 where L1 is the width of the TAC film 3 at the boundary of the first zone 21 and the second zone 22, and L2 is a maximum width of the TAC film 3 in the tenter section 5, that is, the width of the TAC film 3 at the release position 26 (see FIG. 2).

The first to third zones 21 to 23 respectively have air conditioners 51 to 53 for independently controlling air conditions, for example the temperature and the moisture of the air in the first to third zones 21 to 23. Moreover, in each first to third zone 21 to 23, there is a circulator (not shown) for circulating the inner air to maintain the conditions of an atmosphere in each first to third zone 21 to 23 uniform. Thus, the degree of progression in drying the TAC film 3 passing through the first to third zones 21 to 23 and the temperature of the TAC film 3 can be made to desired values. Note that a content of remaining solvent in the TAC film 3 can be an indication of the degree of progression in drying the TAC film 3.

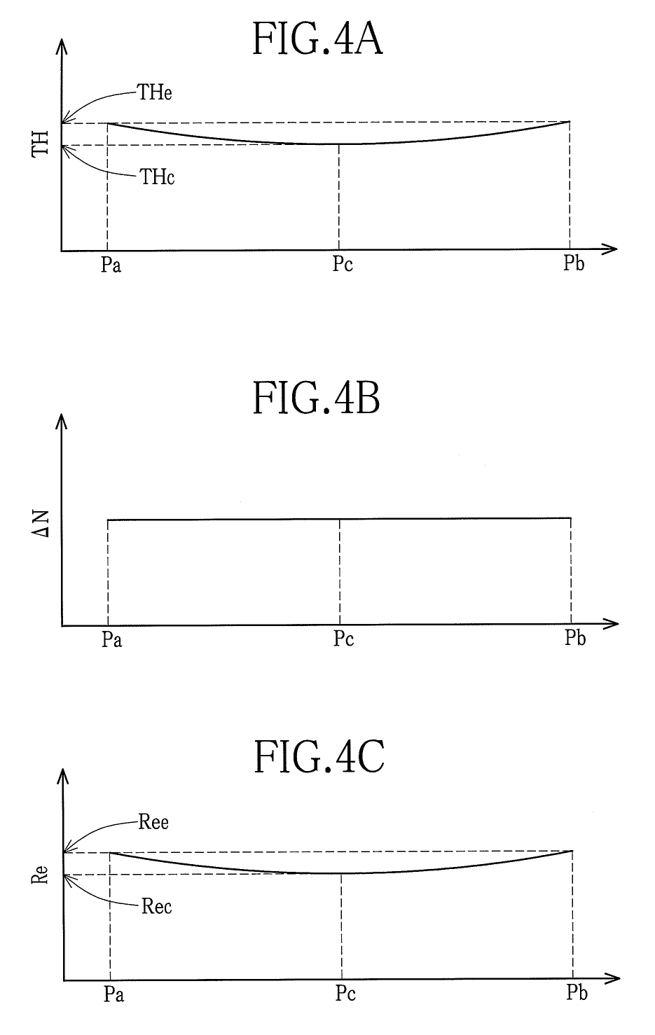

Next, a thickness TH, a birefringence ΔN, and an in-plane retardation Re of the TAC film 3 before the stretching process is explained with referring to FIGS. 4A to 4C. In FIGS. 4A to 4C, a horizontal axis indicates positions on the TAC film 3 in the width direction TD. “Pa” represents the side edge portion 3a, “Pb” represents the side edge portion 3b, and “Pc” represents a center portion 3c. A vertical axis in FIG. 4A indicates the thickness TH, a vertical axis in FIG. 4B indicates the birefringence ΔN, and a vertical axis in FIG. 4C indicates the in-plane retardation Re. Note that the birefringence ΔN is the difference between “Nx” and “Ny” where “Nx” is a refractive index in the slow axis direction of the TAC film 3 and “Ny” is a refractive index in a direction approximately perpendicular to the slow axis direction of the TAC film 3. The in-plane retardation Re is calculated by the following formula (3):

Re=TH×(Nx−Ny) (3)

where “TH” is the thickness of the TAC film 3, “Nx” is the refractive index in the slow axis direction of the TAC film 3, and “Ny” is the refractive index in the direction approximately perpendicular to the slow axis direction of the TAC film 3.

As shown in FIG. 4A, the TAC film 3 before the stretching process has a thickness profile in which the thickness TH decreases from the side edge portions toward the center portion in the width direction TD. As shown in FIG. 4B, the birefringence ΔN of the TAC film 3 before the stretching process is made approximately uniform. Accordingly, the TAC film 3 before the stretching process has a retardation profile in which the in-plane retardation Re decreases from the side edge portions toward the center portion in the width direction TD, as shown in FIG. 4C. The in-plane retardation Re of the TAC film 3 before the stretching process is preferably at least −20 nm and at most 20 nm. A thickness retardation Rth of the same is preferably at least 100 nm and at most 300 nm. Here, the thickness retardation Rth is calculated by the following formula (4):

Rth=TH×{(Nx+Ny)/2−Nth} (4)

where “Nth” is a refractive index in the thickness direction of the TAC film 3.

The length of the TAC film 3 is preferably at least 100 m. The width of the TAC film 3 is preferably at least 600 mm, and more preferably at least 1400 mm and at most 2500 mm. Even if the width is more than 2500 mm, the present invention is effective. Moreover, even if the thickness is at least 40 μm and at most 120 μm, the present invention can be applied.

The content of remaining solvent in the TAC film 3 is preferably at least 0.1 wt. % and at most 10 wt. %. Here, the content of remaining solvent in the TAC film 3 is on a dry basis and calculated by the following formula: {(x−y)/y}×100 where “x” is a weight of the TAC film 3 at the time of sampling and “y” is a weight of the same after drying.

The stretching process of the TAC film 3 in the tenter section 5 is explained in detail. As shown in FIG. 2, the side edge portion 3a, 3b of the TAC film 3 are held with the clips 32a, 32b at the hold position 25. The TAC film 3 is then guided to the release position 26 along with the clips 32a, 32b. The side edge portions 3a, 3b of the TAC film 3 are released from the clips 32a, 32b at the release position 26. The TAC film 3 is then guided to the third zone 23. The transfer rollers 28 transfer the TAC film 3 to the exit 5b and to the edge slitting device 12. The air conditioners 51 to 53 control the atmosphere of the first to third zones 21 to 23 to be the predetermined drying conditions, respectively. The TAC film 3 passes through the first to third zones 21 to 23 is dried according to the different drying conditions of each zone 21 to 23.

The TAC film 3 whose side edge portions 3a, 3b are held with the clips 32a, 32b passes through the first zone 21 while maintaining the width of L1. The TAC film 3 then passes through the second zone 22 while the width is gradually widened from L1 to L2. Since the side edge portions 3a, 3b are released from the clips 32a, 32b at the release position 26, the TAC film 3 passes through the third zone 23 while naturally contracting its width.

In the second zone 22, the stretching process is performed at the stretching ratio Lx of at least 20% and at most 70% in the width direction TD. The stretching ratio Lx is preferably at least 25% and at most 65%, and more preferably at least 30% and at most 60%. When the stretching ratio Lx is less than 20%, the in-plane retardation Re is not sufficiently increased, which is not preferable. When the stretching ratio Lx is more than 70%, on the other hand, haze of the TAC film 3 may be enhanced and the TAC film 3 may be torn, which is not preferable.

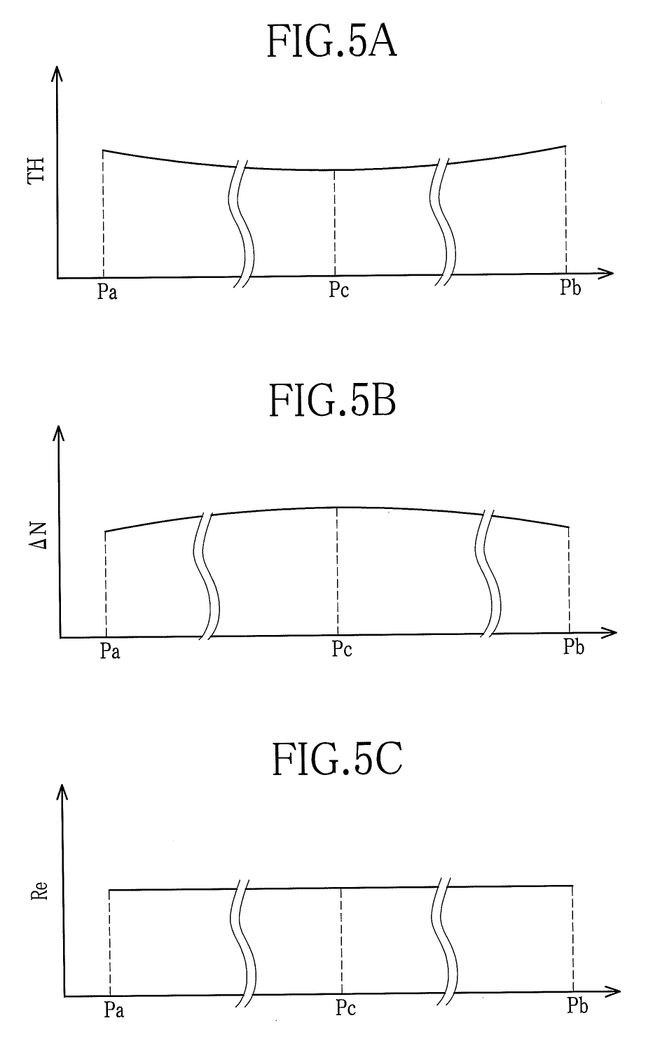

In the stretching process, the TAC film 3 is stretched in the width direction TD while the side edge portions 3a, 3b are being held. At this time, the polymer molecules orientation is more likely to occur in the center portion. That is, the tendency of occurrence of the polymer molecules orientation increases from the side edge portions toward the center portion in the width direction TD. Owing to this, an increase in the refractive index Nx becomes larger from the side edge portions 3a, 3b toward the center portion 3c after the stretching process while the refractive index Ny is approximately uniform before and after the stretching process. As a result, an increase in the birefringence ΔN becomes larger from the side edge portions 3a, 3b toward the center portion 3c after the stretching process (see FIGS. 4B and 5B). Accordingly, an increase in the in-plane retardation Re of the TAC film 3 becomes larger from the side edge portions 3a, 3b toward the center portion 3c after the stretching process. Thus, a difference of the increase in the in-plane retardation Re in the width direction TD is caused by the TAC film's stretching property that decreases as closer to the side edge portions.

In the present invention, the TAC film 3 to be stretched has the thickness profile in which the thickness TH decreases from the side edge portions toward the center portion in the width direction TD (see FIG. 4A). This thickness profile causes a difference of the in-plane retardation Re in the width direction TD before the stretching step. The difference of the increase in the in-plane retardation Re in the width direction TD after the stretching process can be compensated by the difference of the in-plane retardation Re in the width direction TD before the stretching step (see FIG. 5C). Accordingly, the TAC film 3 with approximately uniform retardation Re in the width direction TD can be effectively produced while controlling the in-plane retardation Re at the desired value.

It is preferable that the thickness profile of the TAC film 3 in the width direction TD before the stretching process satisfies the above-mentioned formulae (1) and (2). When the value of THe/THc is less than 1.02, the difference of the increase in the in-plane retardation Re after the stretching process cannot be sufficiently compensated. When the value of THe/THc is more than 1.04, on the other hand, the TAC film 3 after the stretching process may still have unevenness in thickness, which is not preferable.

Note that the shape of the thickness profile of the TAC film 3 in the width direction TD is not limited to the one described above. According to the present invention, similar effect as the above embodiment can be obtained when the stretching process is performed by adjusting respective parameters such as the stretching ratio Lx, the temperature of the TAC film 3, and the stretching speed according to a thickness profile of the TAC film 3.

In the above embodiment, the refractive index Ny is made approximately uniform before and after the stretching process. However, the present invention is not limited to this. When the refractive index Ny differs between before and after the stretching process, the stretching conditions are adjusted according to the difference between the refractive index before the stretching and the refractive index after the stretching, and thereby compensating the difference of the increase in the in-plane retardation Re in the width direction TD after the stretching process by the difference of the in-plane retardation Re in the width direction TD before the stretching process.

It is preferable that temperatures of the side edge portions 3a, 3b of the TAC film 3 before and/or during the stretching process is higher than a temperature of the center portion 3c. In order to do so, for example, the first zone 21 and/or the second zone 22 of the off-line stretching device 2 may be provided with ducts 56, 57, dry air supply sections 61, 62, and a controller 65. The ducts 56, 57 respectively face the side edges 3a, 3b of the TAC film 3. The dry air supply sections 61, 62 respectively supply hot dry air 400, 401. The controller 65 independently controls the conditions such as the temperature and the humidity of the hot dry air 400, 401. Under the control of the controller 65, the hot dry air 400, 401 that are higher than the temperature of the atmosphere in the first zone 21 and/or the second zone 22 are sent to the side edge portions 3a, 3b. Thus, the temperatures of the side edge portions 3a, 3b of the TAC film 3 passing the first zone 21 and/or the second zone 22 can be made higher than the temperature of the center portion 3c.

Here, the temperature of the TAC film 3 in the first zone 21 is adjusted to be preferably at least 130° C. and at most 190° C. by the air conditioner 51, and the temperature of the TAC film 3 in the second zone 22 is adjusted to be preferably at least 130° C. and at most 190° C. by the air conditioner 52. At the same time, the temperatures of the side edge portions 3a, 3b are adjusted to be preferably at least 1° C. and at most 20° C. higher than the temperature of the center portion 3c, and more preferably at least 2° C. and at most 18° C. higher. Note that another pair of ducts 56, 57 may be provided across the TAC film 3 so that the hot dry air 400, 401 are applied to both surfaces of the TAC film 3.

In the above embodiment, the TAC film 3 is stretched in the width direction TD. The present invention is not limited to this. The TAC film 3 may be stretched in a direction at an angle of θ1 with respect to the width direction TD. The angle θ1 is more than 0° and less than 90°.

When the thickness differs between the side edge portions 3a and 3b, the temperature of the hot dry air applied to the thicker side edge portion is made higher than the temperature of the hot dry air applied to the thinner side edge portion.

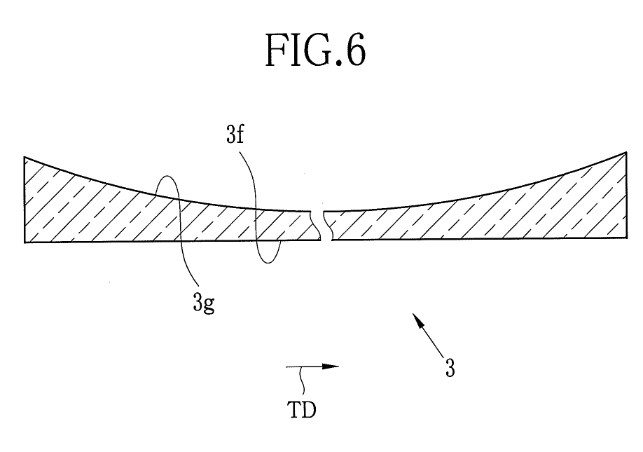

As shown in FIG. 6, the TAC film 3 before the stretching has one surface 3g concave and the other surface 3f flat. It is also possible that the both surfaces 3g, 3f are made concave.

In the above embodiment, the TAC film 3 having the above-described thickness profile is stretched. However, the present invention is not limited to this. The TAC film having the retardation profile in which the in-plane retardation Re decreases from the side edge portions toward the center portion in the width direction TD, which is not caused by the thickness profile, may also be stretched. An example of such TAC film has a thickness that is approximately uniform in the width direction TD and content concentration C1 of retardation increasing agent that decreases from the side edge portions toward the center portion. Note that the content concentration C1 is weight concentration of the retardation increasing agent in a TAC film 103.

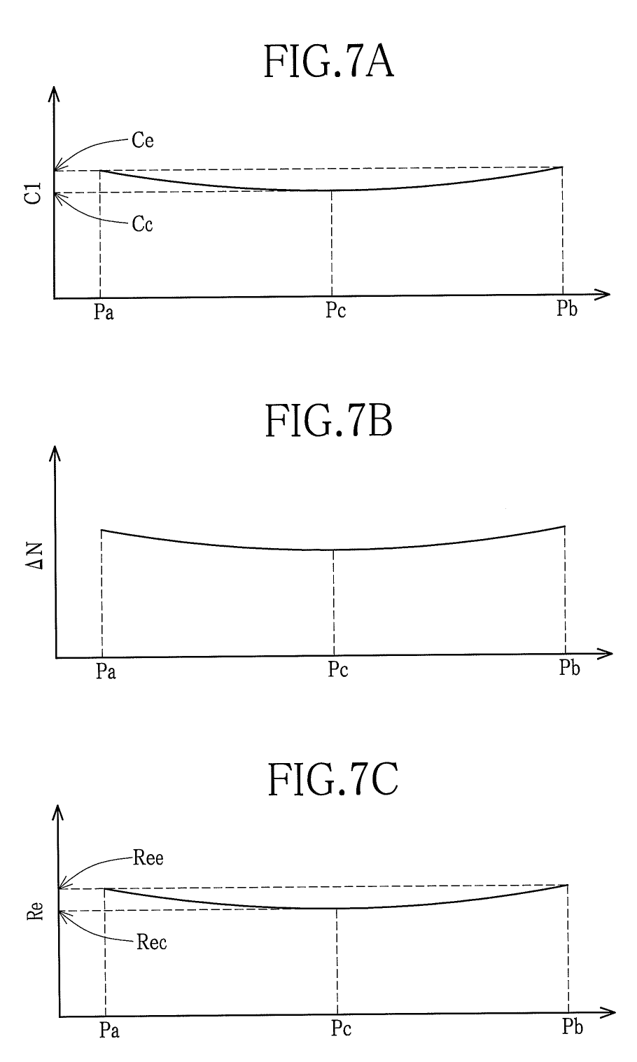

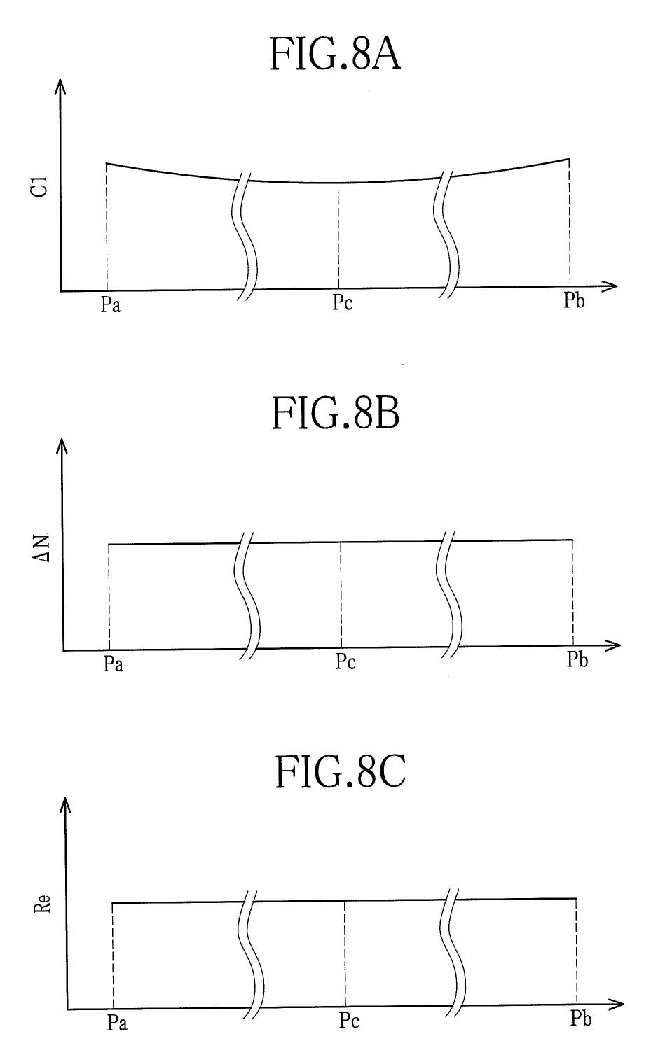

As shown in FIGS. 7A and 7B, the TAC film 103 has a profile of the retardation increasing agent in which the content concentration C1 of the retardation increasing agent decreases from the side edge portions toward the center portion and the retardation profile in which the in-plane retardation Re decreases from the side edge portions toward the center portion. At this time, the thickness of the TAC film 103 is approximately uniform in the width direction TD. The TAC film 103 is stretched in the width direction TD while side edge portions thereof are being held. A difference in the content concentration C1 of the retardation increasing agent in the width direction TD is approximately uniform between before and after the stretching process (see FIGS. 7A and 8A). The increase in the refractive index Nx becomes larger from the side edge portions toward the center portion after the stretching process while the refractive index Ny is approximately uniform before and after the stretching process. As a result, the birefringence ΔN becomes approximately uniform in the width direction TD after the stretching process (see FIGS. 7B and 8B). Accordingly, the in-plane retardation Re of the TAC film 103 can be made approximately uniform from the side edge portions toward the center portion after the stretching process (see FIGS. 7C and 8C).

It is preferable that the profile of the content concentration C1 of the retardation increasing agent of the TAC film 103 in the width direction TD before the stretching process satisfies the following formulae (5) and (6):

1.02≦Ce/Cc≦1.04 (5)

Ce−Cc≦0.3 (wt. %) (6)

where Ce is a content concentration C1 of the side edge portion and Cc is a content concentration C1 of the center portion.

In addition to the above embodiments, the TAC film whose average acetylation degree of TAC increases from the side edge portions toward the center portion in the width direction TD may also be used. In this case, the average acetylation degree of TAC at the side edge portion is preferably at least 0.5% lower than the center portion, and more preferably at least 1.0% lower than the same.

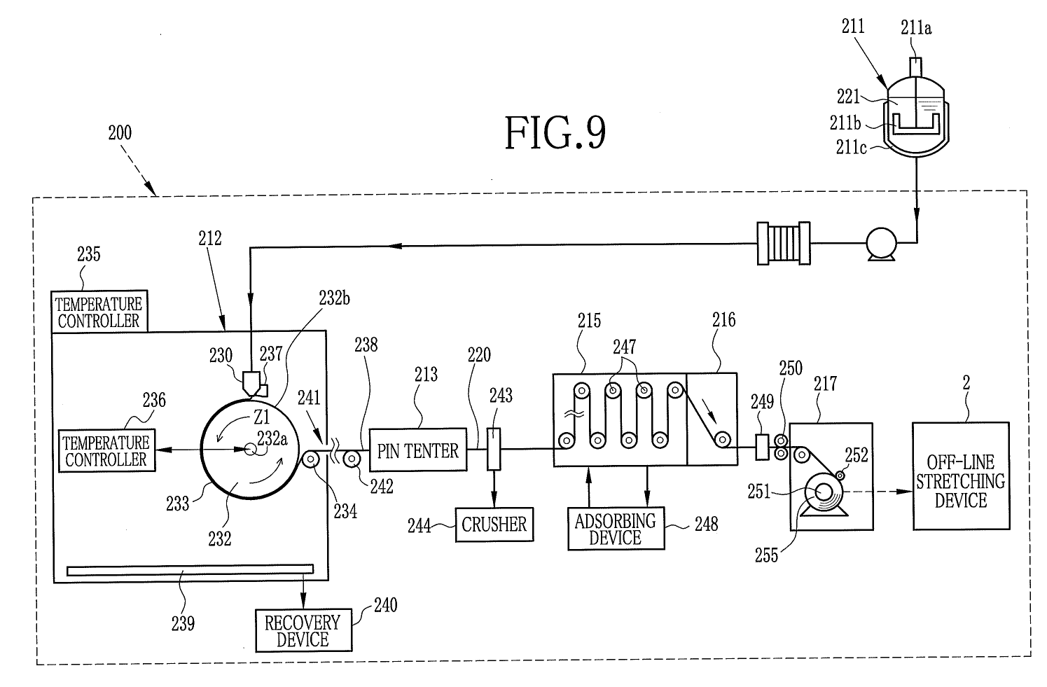

In FIG. 9, a solution casting apparatus 200 is illustrated. The solution casting apparatus 200 includes a stock tank 211, a casting chamber 212, a pin tenter 213, a drying chamber 215, a cooling chamber 216, a winding chamber 217, and the off-line stretching device 2.

The stock tank 211 is provided with a motor 211a, a stirrer 211b to be rotated by the drive of the motor 211a, and a jacket 211c. The stock tank 211 contains a dope 221 in which a polymer as a raw material of the TAC film 3 is dissolved in a solvent. The temperature of the dope 221 in the stock tank 211 is maintained approximately constant by the jacket 211c. Owing to the rotation of the stirrer 211b, the polymer and the like are prevented from agglomerated, and thereby keeping the quality of the dope 221 uniform.

The casting chamber 212 is provided with a casting die 230, a casting drum 232 as a casting support, a peel roller 234, temperature controllers 235, 236, and a decompression chamber 237. The casting drum 232 rotates around a shaft 232a in a direction Z1 by the drive of a drying mechanism (not shown). The temperature controllers 235, 236 set the temperature inside the casting chamber 212 and the temperature of the casting drum 232 to the values facilitating gelation of a casting film 233.

The casting die 230 has a slit extending in the width direction TD. The casting die 230 casts the dope 221 from the slit onto a peripheral surface 232b of the casting drum 232 rotating. Thus, the casting film 233 is formed from the dope 221 on the peripheral surface 232b of the casting drum 232. While the casting drum 232 makes about ¾ rotation, the casting film 233 exerts a self-supporting property by the gelation. The casting film 233 with the self-supporting property is then peeled by the peel roller 234 from the casting drum 232 as a wet film 238. The content of remaining solvent in the casting film 233 at the time of the peeling is preferably at least 150 wt. % and at most 320 wt. %.

The decompression chamber 237 is disposed upstream from the casting die 230 in the direction Z1. Inside the decompression chamber 237 is set to a negative pressure. A rear side (the side contacting the peripheral surface 232b later) of a casting bead is decompressed by the decompression chamber 237 at a desired value. Owing to this, the influence of air caused by the rotation of the casting drum 232 is reduced, and thereby stabilizing the shape of the casting bead. Thus, the casting film 233 with less unevenness in thickness can be formed.

The material of the casting die 230 should have high corrosion resistance in a mixture liquid of electrolyte solution, dichloromethane and methanol and low coefficient of thermal expansion. The finish accuracy of the contact surface of the casting die 230 to the dope 221 is at most 1 μm in surface roughness and at most 1 μm/m in straightness in any direction.

Chrome plating is preferably performed to the peripheral surface 232b of the casting drum 232 such that the drum 232 has enough resistance of corrosion and strength. To maintain the temperature of the peripheral surface 232b at a desired value, a heat transfer medium is circulated by the temperature controller 236. Owing to the circulation of the transfer medium through a path provided in the casting drum 232, the temperature of the peripheral surface 232b is maintained at the desired value.

The width of the casting drum 232 is not restricted especially. However, the width is preferably 1.1 times to 2.0 times as large as the casting width of the dope. The casting drum 232 is preferably made of stainless steel, and especially of SUS 316 so as to have enough resistance of corrosion and strength. The chrome plating performed to the peripheral surface 323b of the casting drum 232 is preferably so-called hard chrome plating with Vickers hardness value of at least Hv700 and a thickness of at least 2 μm.

Moreover, in order to adjust a film thickness, the casting die 230 is preferably provided with an automatic thickness adjusting device. For example, thickness adjusting bolts (heat bolts) are disposed at predetermined intervals in a widthwise direction of the casting die 230. The slit clearance of the casting die 230 is adjusted such that the clearances at both edges are made wider than the clearance of the center in the widthwise direction. For this configuration, the TAC film having the above-described thickness profile can be produced.

Furthermore, a liquid including the retardation increasing agent or a TAC having lower average acetylation degree than the TAC contained in the solvent is supplied near both side edges of the casting bead. After the supply of the liquid, the retardation increasing agent or the TAC having lower average acetylation degree is dispersed in the casting film 233, the wet film 238, or a film 220. As a result, the TAC film having the above-described retardation profile can be produced.

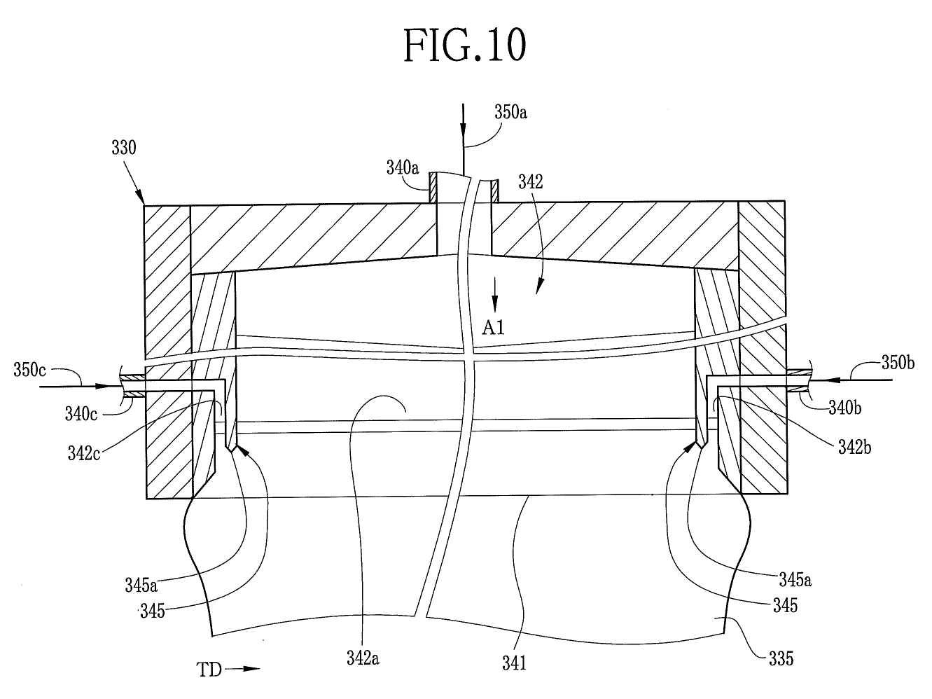

It is also possible to use a casting die 330 shown in FIG. 10 for producing the TAC film having the above-described retardation profile. The casting die 330 is provided with first to third supply ports 340a to 340c for supplying dopes, a discharge port 341 for casting the dope as a casting bead 335, and a slot 342 communicated with the first supply port 340a and the discharge port 341. The slot 342 is provided with a pair of partitioning members 345 extending in a dope-flowing direction A1. The partitioning members 345 partition inside the slot 342 into three parts in the width direction TD: a center slot 342a, and side edge slots 342b and 342c. The side edge slot 342b is connected to the second supply port 340b, and the side edge slot 342c is connected to the third supply port 340c. The partitioning members 345 each have a sharp edge 345a. To the first supply port 340a, a center dope 350a is supplied. To the second and third supply ports 340b, 340c, side edge dopes 350b, 350c are respectively supplied. The dopes 350a to 350c passed through the corresponding slots 342a to 342c are merged via the edges 345a of the partitioning members 345, and then cast from the discharge port 341 as the casting bead 335. At this time, the side edge dopes 350b, 350c have higher content concentration C1 of the retardation increasing agent than the center dope 350a. Owing to this, a formed casting film has the above-described retardation profile, and which results in producing a TAC film having the same retardation profile as the casting film.

The thickness of the casting bead 335 increases as the flow amount of each dope 350a to 350c passing through the corresponding slot 342a to 342c increases. Based on this principle, the flow amount of each dope 350a to 350c can be individually controlled by a pump (not shown) such that the flow amount of the side edge dope 350b in the side edge slot 342b and the flow amount of the side edge dope 350c in the side edge slot 342c become larger than the amount of the center dope 350a in the center slot 342a. When the dopes 350a to 350c with the flow amount controlled as described above are merged and cast from the discharge port 341. In this way, the TAC film having the above-described thickness profile can be produced. In addition, the thickness of the casting bead 335 increases as the flow speed of each dope 350a to 350c passing through the corresponding slot 342a t 342c increases. Based on this principle, each slot 342a to 342c may be designed such that the flow speed of each side edge dope 350b, 350c becomes faster than the flow speed of the center dope 350a.

Although it is preferable that the flow amount and the flow speed between the side edge dopes 350b, 350c in the corresponding side edge slots 342b, 342c are same, they may differ from each other. The content concentration C1 of the retardation increasing agent in each dope 350b, 350c may be same as the center dope 350a, or may be differ from each other.

The casting chamber 212 is provided with a condenser 239 and a recovery device 240. The condenser 239 condenses and liquefies solvent gas evaporated. The recovery device 240 recovers the liquefied solvent. The recovered solvent is refined by a refining device as the solvent to be reused for preparing the dope.

A transfer section 241 is disposed downstream from the casting chamber 212 and followed by the pin tenter 213. The transfer section 241 is provided with a number of rollers 242. The wet film 238 is fed to the pin tenter 213 by the rollers 242. The pin tenter 213 has pin plate whose pins pierce the side edge portions of the wet film 238. The pin plate runs on the rail. Dry air is applied to the wet film 238 running along with the pin plate, and thereby the wet film 238 is dried to be the film 220.

The pin tenter 213 is provided with clips for holding the side edge portions of the film 220. The clips run on the rail. Dry air is applied to the film 220 running along with the clips, and thereby the film 220 is dried while being stretched in the width direction TD.

An edge slitting device 243 is disposed downstream from the pin tenter 213. The edge slitting device 243 slits the side edge portions of the film 220. The slit edges are sent to a crusher 244 by a blowing device (not shown) and crushed into chips by the crusher 244. The chips are reused for preparing the dope.

The drying chamber 215 is provided with plural rollers 247. In the drying chamber 215, the film 220 is bridged across the rollers 247 and transported. On the exit side of the drying chamber 215 is disposed the cooling chamber 216. The film 220 is cooled down to approximately the room temperature in the cooling chamber 216. A neutralization device (neutralization bar) 249 is disposed downstream from the cooling chamber 216. The film 220 is neutralized in the neutralization device 249. A knurling roller pair 250 is disposed downstream from the neutralization device 249. The knurling roller pair 250 forms knurling on both side edges of the film 220. In the winding chamber 217, a winding roller 251 and a press roller 252 are provided. The film 220 is wound up by the winding roller 251 while the press roller 252 controls tension thereof. Thus, a film roll 255 wound around a roll core is obtained.

The film roll 255 is sent from the winding chamber 217 to the film supply chamber 4 of the off-line stretching device 2 (see FIG. 1), and fed from the film supply chamber 4 as the TAC film 3.

In the above embodiment, the stretching process is performed in the off-line stretching device 2. However, the present invention is not limited to this. The stretching process similar to the one performed in the off-line stretching device 2 may be performed between the pin tenter 213 and the drying chamber 215 of a solution casting apparatus 200.

In the above embodiment, the TAC films 3 and 103 are the examples of the polymer film. The present invention is applicable not only for the TAC films 3 and 103, but also for various kinds of polymer films.

In the above embodiment, the casting drum 232 is used as the casting support. However, the casting support may be a different form other than the casting drum 232. For example, an endless belt that is turned about by two driving rollers may be the casting support.

In the above embodiment, the casting film 233 is cooled to possess the self-supporting property. However, the self-supporting property may be developed by drying the casting film 233.

In the above embodiment, the casting film is formed from a single dope. However, the present invention is not limited to this. In the solution casting of the present invention, the dopes, namely two or more sorts of dopes, can be cast according to simultaneous co-casting or sequential co-casting, or a combination of the both. When the simultaneous co-casting is performed, a feed block may be attached to the casting die, or a multi-manifold type casting die may be used. A thickness of at least one surface layer, which is exposed to outside, of a multi-layered membrane is preferably in the range of 0.5% to 30% to the total thickness of the film. Moreover, in the simultaneous co-casting method, it is preferable to preliminary adjust each dope's viscosity such that the lower viscosity dopes entirely cover over the higher viscosity dope when the dopes are cast onto the support from the die slit. Furthermore, in the simultaneous co-casting method, it is preferable that the inner dope is covered with dopes whose alcohol composition ratio is larger than that of the inner dope in the bead, which is formed between the die slit and the support.

In the above embodiment, the TAC film is used. However, the present invention is not limited to this. Besides the cellulose acylate film, films made of other polymers, such as cyclic olefin, and produced according to the solution casting method may be used.

[Cellulose Acylate]

As cellulose acylate, triacetyl cellulose (TAC) is especially preferable. It is preferable in cellulose acylate that the ratio of hydroxyl groups of cellulose esterified with carboxylic acid, that is, the degree of substitution of acyl groups preferably satisfies all of following formulae (I)-(III). In these formulae (I)-(III), substation degree A is the degree of substitution of the acetyl groups, and substitution degree B is the degree of substitution of the acyl groups each having 3 to 22 carbon atoms. Note that at least 90 wt. % of TAC is particles having diameters from 0.1 mm to 4 mm.

2.5≦A+B≦3.0 (I)

0≦A≦3.0 (II)

0≦B≦2.9 (III)

Further, polymer to be used in the present invention is not restricted in cellulose acylate.

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particularly 2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferably the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.7. According to DSB, the percentage of the substitution on the 6^{th} position to that on the 2^{nd}, 3^{rd} and 6^{th} positions is at least 20%. The percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability. Note that the dope contains a polymer and a solvent for dissolving the polymer. Further, if necessary, an additive is added to the dope.

The cellulose as the raw material of the cellulose acylate may be obtained from one of the pulp and the linter.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinamoyl group and the like, and the especially preferable groups are propionyl group and butanoyl group.

[Solvent]

Further, as solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. Note that the dope is a polymer solution or dispersion in which a polymer and the like is dissolved to or dispersed in the solvent. It is to be noted in the present invention that the dope is a polymer solution or a dispersion that is obtained by dissolving or dispersing the polymer in the solvent.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 wt. % to 25 wt. %, and particularly in the range of 5 wt. % to 20 wt. %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 carbons, and alcohols having 1 to 12 carbons are preferable, and a mixture thereof can be used adequately. For example, there is a mixture of methyl acetate, acetone, ethanol and n-butanol. These ethers, ketones, esters and alcohols may have the ring structure. Further, the compounds having at least two of functional groups in ethers, ketones, esters and alcohols (namely, —O—, —CO—, —COO— and —OH) can be used for the solvent.

Note that the detailed explanation of cellulose acylate is made from [0140] to [0195] in Japanese Patent Laid-Open Publication No. 2005-104148, and the description of this publication can be applied to the present invention. Note that the detailed explanation of the solvents and the additive materials of the additive (such as plasticizers, deterioration inhibitors, UV-absorptive agents, optical anisotropy controllers, dynes, matting agent, release agent, retardation controller and the like) is made from [0196] to [0516] in Japanese Patent Laid-Open Publication No. 2005-104148.

In the above embodiment, the TAC film produced in the solution casting method is used. However, the TAC film produced in a melt extrusion method may also be used.

(Melt Extrusion Apparatus)

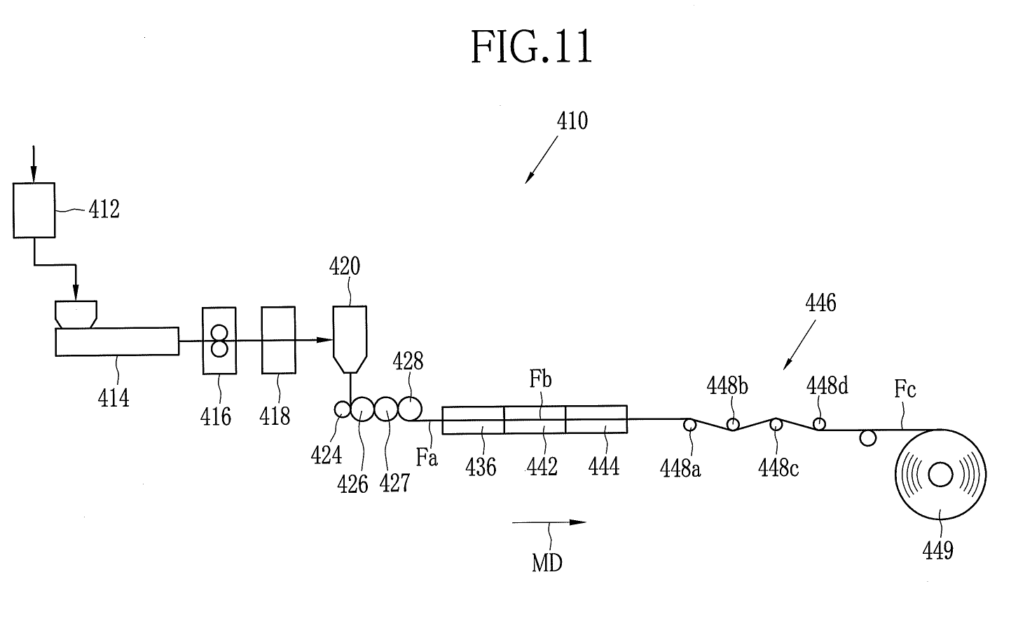

Next, an apparatus for producing polymer films according to the melt extrusion method (hereinafter, the melt extrusion apparatus) is explained. FIG. 11 shows a melt extrusion apparatus 410 for producing a film Fc usable for liquid crystal display device. Pellets of thermoplastic resin as a raw material of the thermoplastic film Fc are fed into a dryer 412 to be dried therein. The dried pellets are melted by an extruder 414 and then supplied to a filter 418 by a gear pump 416. In the filter 418, the melted thermoplastic resin (melted resin) is filtrated to remove foreign matters therefrom. The melted resin is then extruded from a die 420. The extruded thermoplastic resin (extruded resin) is firstly nip pressed between a touch roll 424 and a first casting roll 426 to be formed into shape and cooled to be geleted into film form with a predetermine surface roughness on the first casting roll 426. The extruded resin in film form is further transported by a second casting roll 427 and a third casting roll 428, and thereby forming an unstretched film Fa. This unstretched film Fa may be wound here or supplied to a stretching section 442. In the stretching section 442, the unstretched film Fa is continuously stretched in the width direction TD over a long span of time. Even in the case where the unstretched film once wound is supplied to the stretching section 442 to be subjected for the continuous long-span stretching, the similar effect can be obtained.

In the stretching section 442, the unstretched film Fa is stretched in the width direction TD perpendicular to the transfer direction MD, and thereby forming a stretched film Fb. A pre-heating section 436 may be provided at upstream side from the stretching section 442 and/or a heat fixation section 444 may be provided at downstream side from the stretching section 442. During the stretching, a bowing phenomenon (disorientation of optical axis) may occur on the film. In the bowing phenomenon, a center portion of the film may be drawn backward in the transfer direction MD with respect to side edge portions of the film. Note that the center portion and the side edge portions are defined in the width direction TD of the film. Owing to the provision of the pre-heating section 436 and/or the heat fixation section 444, degree of bowing phenomenon can be lowered. The pre-heating temperature is preferably higher than the stretching temperature and the heat fixation temperature is preferably lower than the stretching temperature. When such conditions, that is, the pre-heating temperature>the stretching temperature, the stretching temperature>the heat fixation temperature are satisfied, the degree of bowing phenomenon can be lowered. It is preferable that at least one of the pre-heating and the heat fixation is performed.

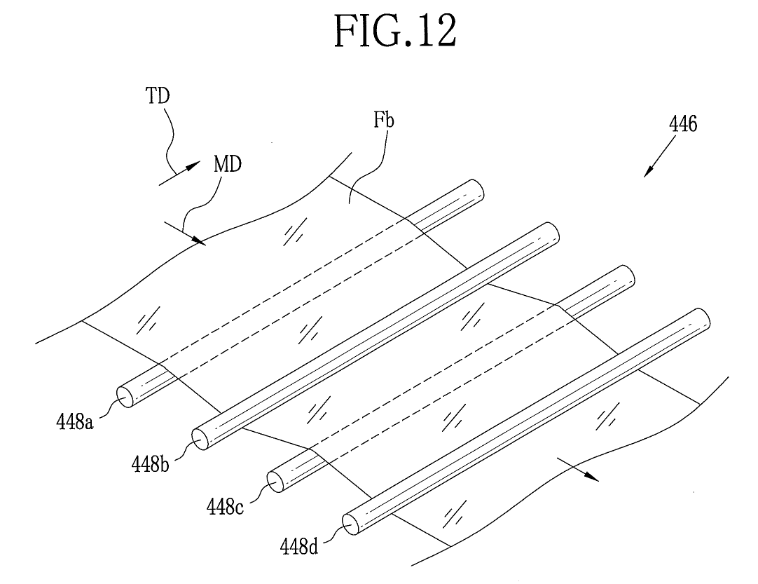

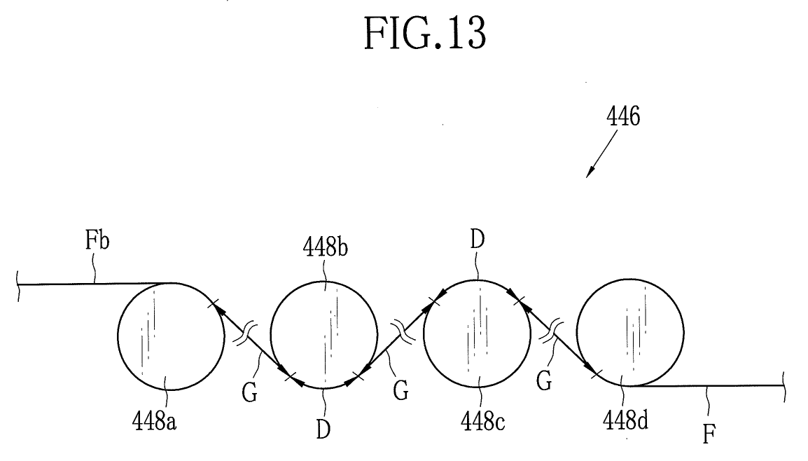

After the heat fixation, the stretched film Fb is contracted in the transfer direction MD in a heat treatment zone 446. In the heat treatment zone 446, the stretched film Fb is transferred by rollers 448a to 448d as shown in FIG. 12. At this time, the side edge portions of the stretched film Fb are not held by a chuck. The stretched film Fb is transferred such that it is contracted only in the transfer direction MD without causing contraction in the width direction TD. The rollers 448a to 448d are arranged so as to satisfy the following condition: a ratio G/D is at least 0.01 and at most 3, where D is a film wrapping length around the roller and G is a film length between two adjacent rollers as shown in FIG. 13. For this configuration, the contraction in the width direction TD of the stretched film Fb is controlled by friction against each roller 448a to 448d. When the peripheral velocity of the roller 448a disposed in the upstream side is V1 and the peripheral velocity of the roller 448d disposed in the downstream side is V2, a ratio V2/V1 is at least 0.6 and at most 0.999. In the heat treatment zone 446, the stretched film Fb is subjected to the heat treatment, that is, contracted in the transfer direction MD while being transferred by the rollers 448a to 448d satisfying the above-described peripheral velocity condition.

Owing to the heat treatment in the heat treatment zone 446, the thermoplastic film Fc with adjusted orientation angle and retardation is produced as a final product. The film Fc is wound by a winding device 449.

Before or after the stretching in the width direction TD, stretching in the transfer direction MD may be performed while transferring the film by nip roller pairs aligned in the transfer direction MD by adjusting the peripheral velocity of the nip roller pair in the downstream side faster than that in the upstream side. Here, the stretching method differs according to a length/width ratio L/W. The length/width ratio L/W used herein means a value obtained by dividing the interval “L” of the nip roller pairs used for the stretching with the width “W” of the film nipped between the rollers in the upstream side to be stretched. When the length/width ratio L/W is small, the stretching methods for stretching the film in the transfer direction MD described in Japanese Patent Laid-Open Publications No.2005-330411 and 2006-348114 are applicable. According to the methods described in these publications, the retardation along the thickness direction (Rth value) tends to be large, but the stretching device can be compact. When the length/width ratio L/W is large, on the other hand, the stretching method for stretching the film in the transfer direction MD described in Japanese Patent Laid-Open Publication No. 2005-301225 is applicable. According to the method described in this publication, the Rth value can be made small, but the stretching device tends to be large.

In the melt extrusion apparatus 410, the die 420 may also be provided with the thickness adjusting bolts (heat bolts) at predetermined intervals in a widthwise direction thereof. The TAC film having the thickness profile in which the thickness of the film decreases from the side edge portions toward the center portion in the width direction TD can be produced by adjusting the slit clearance of the die 420 such that the clearances at both edges are made wider than the clearance of the center in the width direction.

The polymers used in the melt extrusion method are not particularly limited as long as they are the thermoplastic resin. The examples of the polymers are, for example, cellulose acylate, lactone ring containing polymer, cyclic olefin and polycarbonate. Preferably used among them are cellulose acylate and cylic olefin, and above all, preferably used are cellulose acylate containing acetate group, cellulose acylate containing propionate group and cyclic olefin obtained by addition polymerization, and more preferably used among them is the cyclic olefin obtained by addition polymerization.

(Cyclic Olefin)

Preferable cyclic olefin is polymerized from norbornene-type compound. The polymerization here may be ring-opening polymerization or addition polymerization. For the addition polymerization, methods described in, for example, Japanese Patent Publications No. 3517471, 3559360, 3867178, 3871721, 3907908, 3945598, Published Japanese Translation No. 2005-527696 of the PCT International Publication, Japanese Patent Laid-Open Publication No. 2006-28993 and International Publication No. WO 2006/004376. Especially preferable method is the one disclosed in the Japanese Patent Publication No. 3517471.

For the ring-opening polymerization, methods described in, for example, International Publication No. WO 98/14499, Japanese Patent Publications No. 3060532, 3220478, 3273046, 3404027, 3428176, 3687231, 3873934 and 3912159. Especially preferable methods are those disclosed in the International Publication No. WO 98/14499 and Japanese Patent Publication No. 3060532.

Among the above-described cyclic olefins, those obtained by the addition polymerization are preferable.

(Lactone Ring Containing Polymer)

Preferable example of lactone ring containing polymer is represented by a chemical formula 1 below.

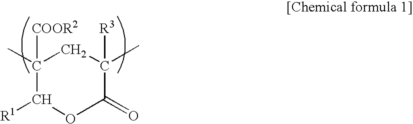

In the chemical formula 1, each of R¹, R², and R³ is either of a hydrogen atom or an organic residue having 1 to 20 carbon atoms. The organic residue may include an oxygen atom.

In the chemical formula 1, percentage of lactone ring structure content is preferably in the range of 5 wt. % to 90 wt. %, more preferably in the range of 10 wt. % to 70 wt. %, and particularly preferably in the range of 10 wt. % to 50 wt. %.

In addition to the lactone ring structure shown in the chemical formula 1, polymer structure unit (repeating structure unit) formed by polymerizing at least one of (meth)acrylic ester, hydroxyl group containing monomer, unsaturated carboxylic acid and monomer represented by a chemical formula 2 below are preferable.

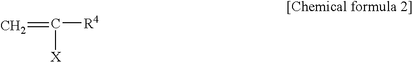

In the chemical formula 2, R⁴ is either of a hydrogen atom or a methyl group, X is any of alkyl group having 1 to 20 carbon atoms, aryl group, —OAc group, —CN group, —CO—R⁵group, or —C—O—R⁶ group where Ac group represents acetyl group, each of R⁵ and R⁶ is either of a hydrogen atom or an organic residue having 1 to 20 carbon atoms.

Preferable examples of lactone ring containing polymers are disclosed in International Publication No. WO 2006/025445, Japanese Patent Laid-Open Publications No. 2007-70607, 2007-63541, 2006-171464 and 2005-162835.

### EXAMPLE 1

The stretching process was performed to the TAC film 3 using the off-line stretching device 2 shown in FIG. 1. The TAC film 3 before the stretching had a width of 2000 mm, a thickness THc of 65 μm, and a thickness ratio THe/THc of 1.03. The TAC film 3 was stretched by a stretch ratio L2/L1 of 1.4 while keeping the temperatures of the side edge portions 3a and 3b 15° C. higher than the temperature of the center portion 3c. The temperature of the center portion 3c was 185° C.

### EXAMPLE 2

The stretching process was performed to the TAC film 3 in the same manner as Example 1 except that the temperatures of the side edge portions 3a and 3b were kept 0.5° C. higher that the temperature of the center portion 3c.

### EXAMPLE 3

The stretching process was performed to the TAC film 3 in the same manner as Example 1 except that the thickness ratio THe/THc was made 1.05 and the temperatures of the side edge portions 3a and 3b were kept 0.5° C. higher than the temperature of the center portion 3c.

### EXAMPLE 4

The stretching process was performed to the TAC film in the same manner as Example 1 except that the thickness ratio THe/THc was made 1.01 and the temperatures of the side edge portions 3a and 3b were kept 0.5° C. higher than the temperature of the center portion 3c.

1. Evaluation of In-plane Retardation (Re)

Part of each TAC film produced in Examples 1 to 4 was cut in the width direction to be sampled. Nine measurement points were set on the sample along the width direction. The moisture of the sample at each measurement point was adjusted under a temperature of 25° C. and a humidity of 60% RH for 2 hours. Then, the in-plane retardation Re in the vertical direction was measured at each measurement point using an automatic birefringence meter (KOBRA21DH made by Oji Scientific Instrument Col, Ltd.). The measurement of the retardation was made at a wavelength of 632.8 nm. The in-plane retardation Re was evaluated based on the following criteria:

Good: ReX was at least 80%

Bad: ReX was less than 80%

where “ReX” is obtained by dividing the width W0 of the whole TAC film by the width W1 of the area whose value of the in-plane retardation Re satisfies the following formula:

|Re−Reₐᵥ|/Reₐᵥ≦0.07

where Reₐᵥ represents an average value of the measured in-plane retardation Re.

2. Evaluation of Variation in Thickness

Among the TAC films to which the stretching process was performed in Examples 1 to 4, the areas whose value of the in-plane retardation Re satisfies the above formula were subjected for the measurement of variation in thickness. The TAC film after being stretched was conditioned at a temperature of 25° C. and a humidity of 60% RH. Under such condition, the measurement was taken at five points of the TAC film using an electronic micrometer made by Anritsu Company, and an average value THₐᵥ of the measurement values TH1 was calculated. The variation in thickness was evaluated based on the following criteria:

Good: |TH1−THₐᵥ|≦2 μm

Bad: |TH1−THₐᵥ|>2 μm

The conditions, measurement values, and evaluation results of Examples 1 to 4 are shown in Table 1. In Table 1, “THe/THc” is the thickness ratio between the thickness THe of the side edge portion of the TAC film and the thickness THc of the center portion of the same. “ΔT” is the temperature difference (Te−Tc) (unit: ° C.), that is, the difference between the temperature Te of the side edge portion of the TAC film during the stretching process and the temperature Tc of the center portion of the same. “Lx” is the stretch ratio whose value is represented by L2/L1. Numbers shown in a column of evaluation in Table 1 are same as those assigned to the evaluation categories.

TABLE 1

| | | | | | Evaluation | |
|---|---|---|---|---|---|---|
| | THe/THc | ΔT | Lx | ReX | 1 | 2 |
| Example 1 | 1.03 | 15 | 1.4 | 85 | Good | Good |
| Example 2 | 1.03 | 0.5 | 1.4 | 80 | Good | Good |
| Example 3 | 1.05 | 0.5 | 1.4 | 80 | Good | Bad |
| Example 4 | 1.01 | 0.5 | 1.4 | 75 | Bad | Good |

According to the results of Examples 1 to 4, the following is understood. Films with uniform in-plane retardation Re in the width direction can be produced by performing the stretching process to the TAC films whose value of THe/THc meets a certain value or more. In addition, the in-plane retardation Re becomes more even in the width direction by performing the stretching process with making the temperatures of the side edge portions as high as possible in the preset range than the temperature of the center portion.

Various changes and modifications are possible in the present invention and may be understood to be within the present invention.

What is claimed is:

1. A film stretching method comprising the steps of:
preparing a film having a thickness profile in which a thickness of said film decreases from side edge portions toward a center portion in a width direction and a retardation profile in which an in-plane retardation Re of said film decreases from said side edge portions toward said center portion in said width direction; and
stretching said film in said width direction while holding said side edge portions, said film having a stretching property decreasing as closer to said side edge portions, said in-plane retardation Re increasing after said stretching step such that an increase in said in-plane retardation Re becomes larger from said side edge portions toward said center portion, said stretching property causing a difference of said increase in said in-plane retardation Re in said width direction, a difference of said in-plane retardation Re in said width direction before the stretching step compensating said difference of said increase in said in-plane retardation Re in said width direction after the stretching step.

2. The film stretching method of claim 1, wherein said thickness profile causing said retardation profile.

3. The film stretching method of claim 1, wherein said film thickness satisfies the following formulae (1) and (2):
1.02≦THe/THc≦1.04 (1)
THe−THc≦3 μm (2)
where THe is a thickness of said side edge portion and THc is a thickness of said center portion.

4. The film stretching method of claim 1, wherein a content of remaining solvent in said film during the stretching step is at least 0.1 wt. % and at most 10 wt. %.

5. The film stretching method of claim 1, wherein temperatures of said side edge portions during the stretching step are at least 1° C. and at most 20° C. higher than a temperature of said center portion.

6. The film stretching method of claim 1, wherein said film is composed of a single layer.

7. A solution casting method comprising the steps of:
casting a dope containing a polymer and a solvent on a support continuously moving and forming a casting film on said support;
peeling said casting film, turned into gel by cooling, as a film, said film having a thickness profile in which a thickness of said film decreases from said side edge portions toward a center portion in a width direction and a retardation profile in which an in-plane retardation Re of said film decreases from said side edge portions toward said center portion in said width direction; and
stretching said film in said width direction while holding said side edge portions, said film having a stretching property decreasing as closer to said side edge portions, said in-plane retardation Re increasing after said stretching step such that an increase in said in-plane retardation Re becomes larger from said side edge portions toward said center portion, said stretching property causing a difference of said increase in said in-plane retardation Re in said width direction, a difference of said in-plane retardation Re in said width direction before the stretching step compensating said difference of said increase in said in-plane retardation Re in said width direction after the stretching step.

8. The solution casting method of claim 7, wherein said thickness profile causing said retardation profile.
